(19) United States
(12) Patent Application Publication
(10) Pub. No.: US 2026/0301240 A1
(43) Pub. Date: Oct. 1, 2026

(54) ADAPTIVE TOKEN COMPRESSION RATIOS FOR EFFICIENT TRANSFORMERS

(71) Applicant: ADOBE INC., San Jose, CA (US)

(72) Inventors: Haoran You, Atlanta, GA (US); Connelly Stuart Barnes, Bellevue, WA (US); Yuqian Zhou, Redmond, WA (US); Yan Kang, Kirkland, WA (US); Sohrab Amirghodsi, Seattle, WA (US); Elya Shechtman, Seattle, WA (US); Zhe Lin, Clyde Hill, WA (US); Lingzhi Zhang, Philadelphia, PA (US); Xiaoyang Liu, Seattle, WA (US)

(21) Appl. No.: 19/090,544

(22) Filed: Mar. 26, 2025

(51) Int. Cl. G06T 11/00; G06T 5/70; G06T 5/77

(52) U.S. Cl. CPC G06T 11/00; G06T 5/70; G06T 5/77

(57) ABSTRACT

A method, apparatus, non-transitory computer readable medium, and system for generating images using adaptive compression ratios include obtaining an input prompt, and generating a plurality of image tokens based on the input prompt. Each of the plurality of image tokens represents an image region. Embodiments then determine a dynamic selectivity value based on an image generation stage. Subsequently, embodiments perform an attention operation on a subset of the plurality of image tokens based on the dynamic selectivity value to obtain an attention output. Embodiments then generate, using an image generation model, a synthetic image based on the attention output.

### BACKGROUND

The following relates generally to data processing, and more specifically to image generation. Data processing involves manipulating different types of data to achieve desired results, such as extracting additional information and insights. Various forms of data processing include image processing, audio processing, sequence prediction, and text processing. Image processing, for example, may involve enhancing the visual quality of an image or extracting specific information from it.

Image generation is a type of image processing that involves the creation of synthetic images. Recently, generative artificial intelligence (AI) models have been developed to generate realistic images. One such model is the Denoising Diffusion Probabilistic Model (DDPM). DDPMs generate samples by transforming an initial random noise distribution into a data distribution over a series of time steps. There have been recent developments in the underlying model architectures behind DDPMs, including convolutional neural network (CNN)-based architectures and transformer-based architectures.

### SUMMARY

Embodiments of the present inventive concepts described herein include systems and methods for generating images with increased efficiency. Transformer-based diffusion models operate by performing attention operations on ‘tokens’, which are a sequence of vectors that represent the image being generated. These tokens represent patches of the image, where each patch is iteratively denoised to generate image content, and after the denoising is complete, the patches are reconstructed to form the final image. According to some aspects, some tokens may need fewer processing operations than others during the iterative generation process of a synthetic image.

Embodiments include an image generation model based on a diffusion transformer (DiT) model. The image generation model includes a router model, which is configured to rank the importance of each image token at each generation stage. The router model lets only selected tokens through to be processed for denoising, sometimes referred to as “token pruning.” Rather than simply using a “top-K tokens” approach, that is, a fixed compression ratio throughout the generation process, the router model is trained using a differentiable training process that allows the model to learn custom compression ratios for each image generation stage. For example, the router model may adjust the number of tokens that skip computation based on the current DiT block and/or the current denoising timestep, thereby increasing computational efficiency by dynamically allocating processing resources where they are most needed.

A method, apparatus, non-transitory computer readable medium, and system for image generation are described. One or more aspects of the method, apparatus, non-transitory computer readable medium, and system include obtaining an input prompt; generating a plurality of image tokens based on the input prompt, wherein each of the plurality of image tokens represents an image region; determining a dynamic selectivity value based on an image generation stage; performing, using an image generation model, an attention operation on a subset of the plurality of image tokens at an image generation stage to obtain an attention output, wherein the subset of the plurality of image tokens is determined based on the image generation stage; and generating, using the image generation model, a synthetic image based on the attention output.

A method, apparatus, non-transitory computer readable medium, and system for image generation are described. One or more aspects of the method, apparatus, non-transitory computer readable medium, and system include obtaining an input prompt; scoring a plurality of image tokens based on the input prompt, wherein each of the plurality of image tokens represents an image region; determining a dynamic selectivity value based on an image generation stage; selecting a subset of the plurality of image tokens based on the scoring and the dynamic selectivity value; and generating, using an image generation model, a synthetic image by processing the selected subset of the plurality of image tokens at the image generation stage.

An apparatus, system, and method for image generation are described. One or more aspects of the apparatus, system, and method include a memory component; a processing device coupled to the memory component, the processing device configured to perform operations comprising: obtaining an input prompt; generating a plurality of image tokens based on the input prompt, wherein each of the plurality of image tokens represents an image region; determining a dynamic selectivity value based on an image generation stage; performing, using an image generation model, an attention operation on a subset of the plurality of image tokens at the image generation stage based on the dynamic selectivity value to obtain an attention output; and generating, using the image generation model, a synthetic image based on the attention output.

### BRIEF DESCRIPTION OF THE DRAWINGS

FIG. 1 shows an example of an image processing system according to aspects of the present disclosure.

FIG. 2 shows an example of an image processing apparatus according to aspects of the present disclosure.

FIG. 3 shows an example of a diffusion transformer (DiT) architecture according to aspects of the present disclosure.

FIG. 4 shows an example of an image generation pipeline according to aspects of the present disclosure.

FIG. 5 shows an example of a pipeline for efficient token selection according to aspects of the present disclosure.

FIG. 6 shows an example of a method a diffusion process according to aspects of the present disclosure.

FIG. 7 shows an example of a method for inpainting an image according to aspects of the present disclosure.

FIG. 8 shows an example of a method for generating images with dynamic token selection according to aspects of the present disclosure.

FIG. 9 shows an example of a step-by-step algorithm for training machine learning (ML) models according to aspects of the present disclosure.

FIG. 10 shows an example of a method for training a diffusion model according to aspects of the present disclosure.

FIG. 11 shows an example of a training pipeline for determining adaptive compression ratios according to aspects of the present disclosure.

FIG. 12 shows an example of router model prediction results according to aspects of the present disclosure.

FIG. 13 shows an example of learned adaptive compression ratios according to aspects of the present disclosure.

FIG. 14 shows an example of a computing device according to aspects of the present disclosure.

### DETAILED DESCRIPTION

Generative AI has transformed creative workflows. Users are able to generate high-quality images by conveying their ideas in a text prompt to generative models. For example, in an ideation phase, a creator begins by conceptualizing a distinct scene or object they wish to visualize. This might be a fantastical creature, a surreal landscape, or a complex object that would be challenging to draw or model by hand. The creator then condenses this idea into a concise, descriptive text prompt, carefully choosing language to capture the salient features of the envisioned scene or object. The prompt might describe colors, shapes, spatial relationships, mood, or any other aspects of the concept that the creator deems important. The creators may utilize a similar process to inpaint or out-paint existing images with new content, as well.

Various deep learning technologies have been developed for image generation tasks. Early approaches included Variational Autoencoders (VAEs), which learn to compress images into a latent space and then reconstruct them, and Generative Adversarial Networks (GANs), which use a competing generator and discriminator architecture to create realistic images. More recently, diffusion-based approaches have seen increased use due to their superior image quality and training stability. These diffusion models work by learning to gradually denoise a random noise distribution into a coherent image over multiple timesteps.

Some diffusion models employ U-Net architectures based on convolutional neural networks (CNNs) to perform the denoising process. CNNs process images using localized filtering operations that capture spatial patterns and hierarchical features. Recent developments have shown that transformer-based architectures, specifically Diffusion Transformers (DiTs), can achieve comparable or superior results. DiTs process images by dividing them into patches, converting these patches into tokens, and applying attention mechanisms to model relationships between different regions of the image. This approach allows the model to capture both local and long-range dependencies in the image generation process.

In DiT-based image generation models, processing time is directly related to the number of tokens being processed, with attention operations becoming particularly computationally intensive as the number of tokens increases. Some conventional approaches focus on reducing the number of tokens processed, for example by only processing tokens in masked regions during inpainting tasks. However, this approach is limited to specific use cases and does not improve efficiency during general image generation. Other approaches attempt to merge similar tokens during processing to reduce computational load. However, merging tokens can lead to loss of fine detail in the generated image. Still other approaches focus on skipping certain processing layers or caching intermediate results. However, these approaches use fixed rules for determining which computations to skip, which leads to suboptimal efficiency gains or quality trade-offs.

Embodiments of the present disclosure improve both the processing speed and the quality of image generation models by dynamically determining how to allocate computational resources across different image generation stages. Embodiments include an image generation model with a router model that is trained to determine the optimum ratio of tokens to process at both each layer (DiT “block”) and each diffusion timestep of the image generation process. Traditionally, learning optimal compression ratios has been impossible because changing from processing e.g., 20% to 21% of tokens, creates a discrete jump in computation that provides no gradient information for learning. The training process includes a fully-differentiable reparameterization technique that enables learning of these optimal ratios. For each layer and timestep, a learnable parameter determines how to weight the outputs between two predefined compression ratios (e.g., processing 20% versus 30% of tokens). By combining these weighted outputs during training, the router model learns the ideal compression ratio for each stage through standard gradient descent, despite the inherently discrete nature of token selection. After training, these learned ratios are stored and used to efficiently allocate computation where it is most needed throughout the image generation process. This training technique can be applied to any DiT architecture to discover optimal compression ratios specific to that model's configuration and training data.

As used herein, a “dynamic selectivity value” refers to a value that controls the proportion of tokens that pass to the next image generation stage after the tokens have been ranked by importance. For example, an image generation model may be configured to generate synthetic image content over 100 timesteps using a model with 28 layers (also referred to herein as “blocks” or DiT blocks). The model may run all 28 DiT blocks for each of the timesteps. For a given DiT block and a given timestep, the model may reference a learned compression ratio (e.g., the dynamic selectivity value) to determine how many of the most important tokens pass to the next block within a given timestep, or to the next timestep if on the final block of the model. For example, if the compression ratio is 0.2, 20% of the tokens may be selected to pass to the next block for processing. The processing may include attention operations.

As used herein, an “importance score” refers to a scalar value that ranks the relative importance of each token in a set of input tokens for processing. Each token may be associated with an importance score each DiT block and at each timestep. In some cases, unlike the dynamic selectivity value which depends on model architecture, the sampling schedule, and the training data, the importance score depends on the input data at inference time. According to some aspects, the importance score is computed by a trained router model that is part of an image generation model.

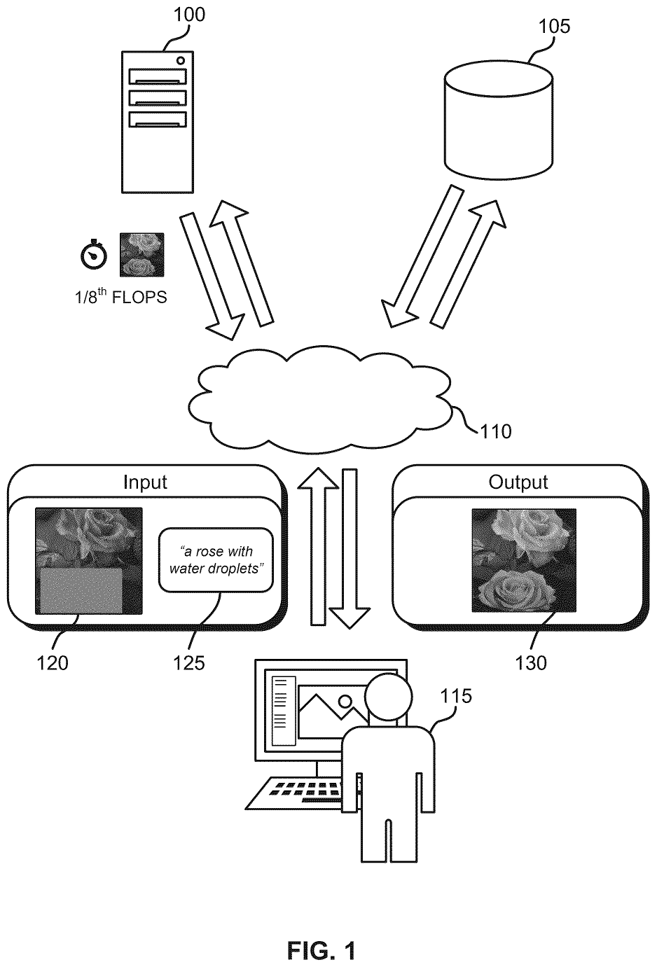

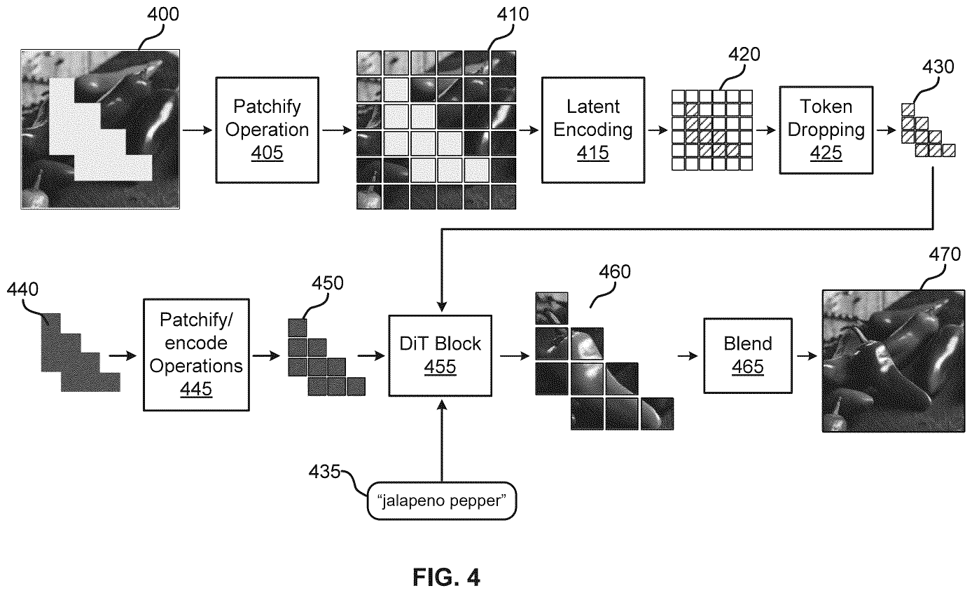

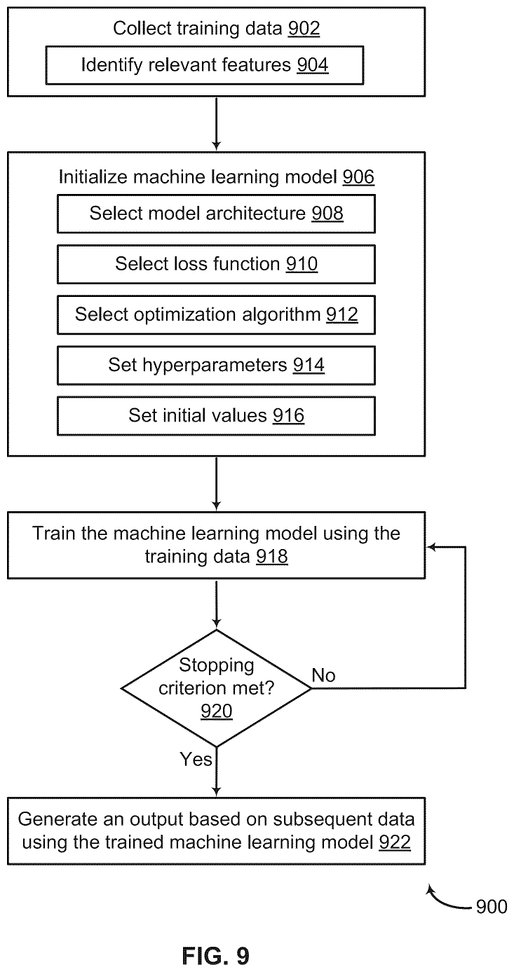

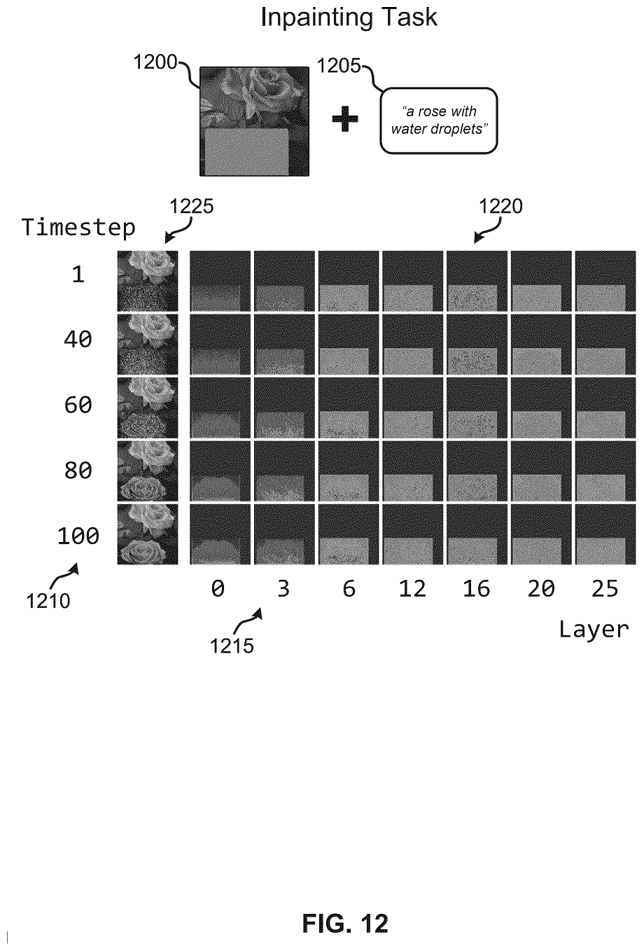

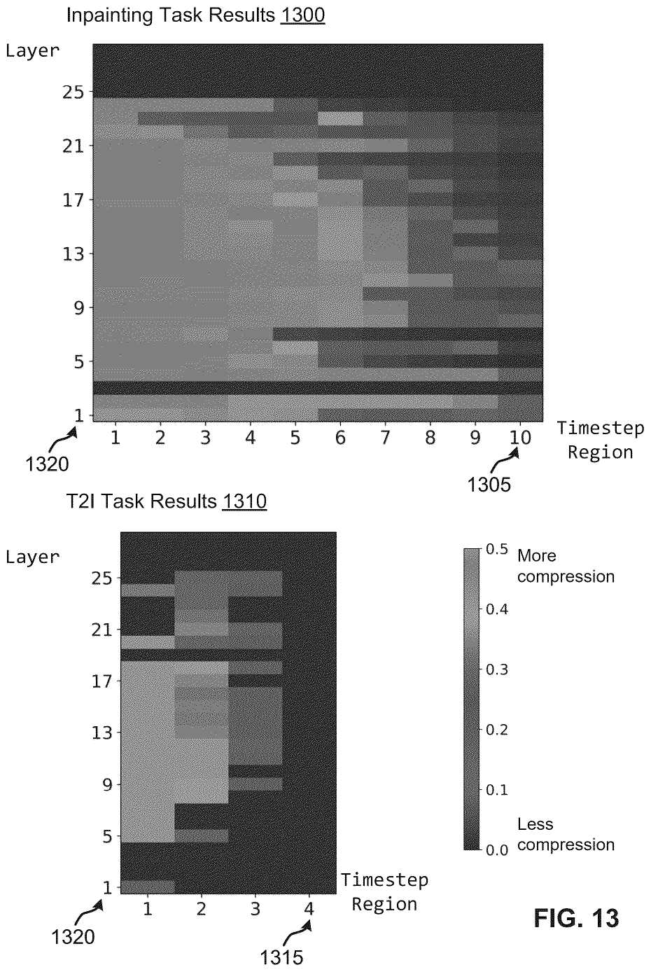

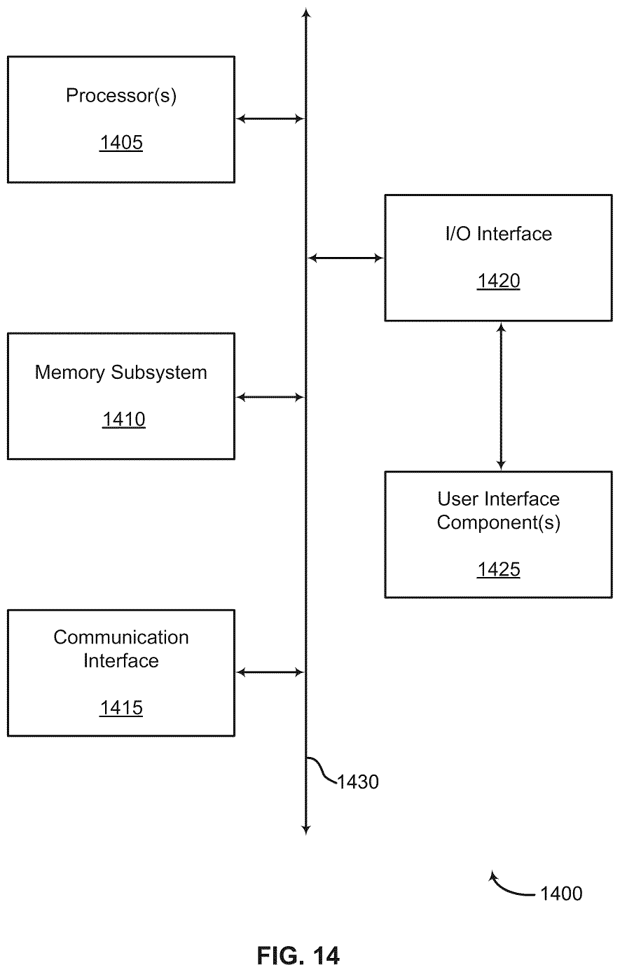

An image processing system is described with reference to FIGS. 1-3. Pipelines and methods for generating synthetic images are described with reference to FIGS. 4-8. Training pipelines and methods are described with reference to FIGS. 9-11. Example results are provided and described with reference to FIGS. 12 and 13. A computing device configured to implement an image processing apparatus is described with reference to FIG. 14.

### Image Processing System

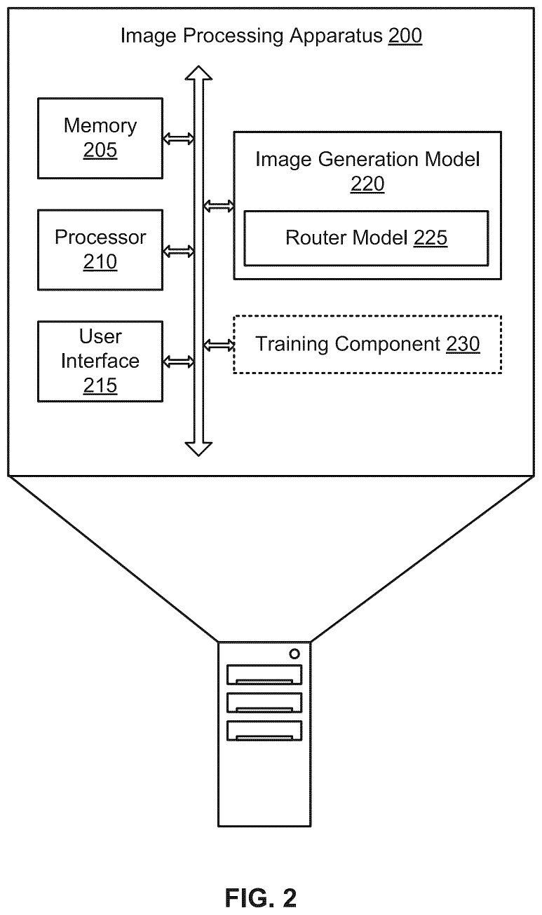

FIG. 1 shows an example of an image processing system according to aspects of the present disclosure. The example shown includes image processing apparatus 100, database 105, network 110, user 115, masked image 120, text prompt 125, and inpainted image 130. Image processing apparatus 100 is an example of, or includes aspects of, the corresponding element described with reference to FIG. 2. Text prompt 125 is an example of, or includes aspects of, the corresponding element described with reference to FIGS. 4, 5, and 12. Inpainted image 130 is an example of, or includes aspects of, the corresponding element described with reference to FIG. 4.

In an example process, user 115 provides masked image 120 and text prompt 125 to the system via a user interface. The user may indicate a region of an existing image to replace with generated content, e.g. by using a drawing tool or a quick-select tool of the user interface. The text prompt 125 describes the content the user wishes to infill into the mask. The user may provide only the text prompt 125, in which case the prompt is used to describe the full image the user wishes to generate. Then, the image processing apparatus 100 processes the inputs by dynamically allocating compute resources over different image generation stages to produce inpainted image 130, which is then presented to the user 115 via the user interface.

Embodiments of image processing apparatus 100 include components that are implemented on a server. A server provides one or more functions to users linked by way of one or more of available networks, such as network 110. In some cases, the server includes a single microprocessor board, which includes a microprocessor responsible for controlling all aspects of the server. In some cases, a server uses microprocessors and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) may also be used. In some cases, a server is configured to send and receive hypertext markup language (HTML) formatted files (e.g., for displaying web pages). In various embodiments, a server comprises a general-purpose computing device, a personal computer, a laptop computer, a mainframe computer, a super computer, or any other suitable processing apparatus.

Database 105 stores information used by the image processing system, such as model parameters, training data, instructions and code libraries, stock images, previously generated images, and the like. A database is an organized collection of data. For example, database 105 stores data in a specified format known as a schema. A database may be structured as a single database, a distributed database, multiple distributed databases, or an emergency backup database. In some cases, a database controller may manage data storage and processing in database 105. In some cases, a user interacts with the database controller. In other cases, the database controller may operate automatically without user interaction.

Network 110 facilitates the transfer of information between image processing apparatus 100, database 105, and user 115. Network 110 may be referred to as a “cloud.” A cloud is a computer network configured to provide on-demand availability of computer system resources, such as data storage and computing power. In some examples, the cloud provides resources without active management by a user. The term cloud is sometimes used to describe data centers available to many users over the Internet. Some large cloud networks have functions distributed over multiple locations from central servers. A server is designated an edge server if it has a direct or close connection to a user. In some cases, a cloud is limited to a single organization. In other examples, the cloud is available to many organizations. In one example, a cloud includes a multi-layer communications network comprising multiple edge routers and core routers. In another example, a cloud is based on a local collection of switches in a single physical location.

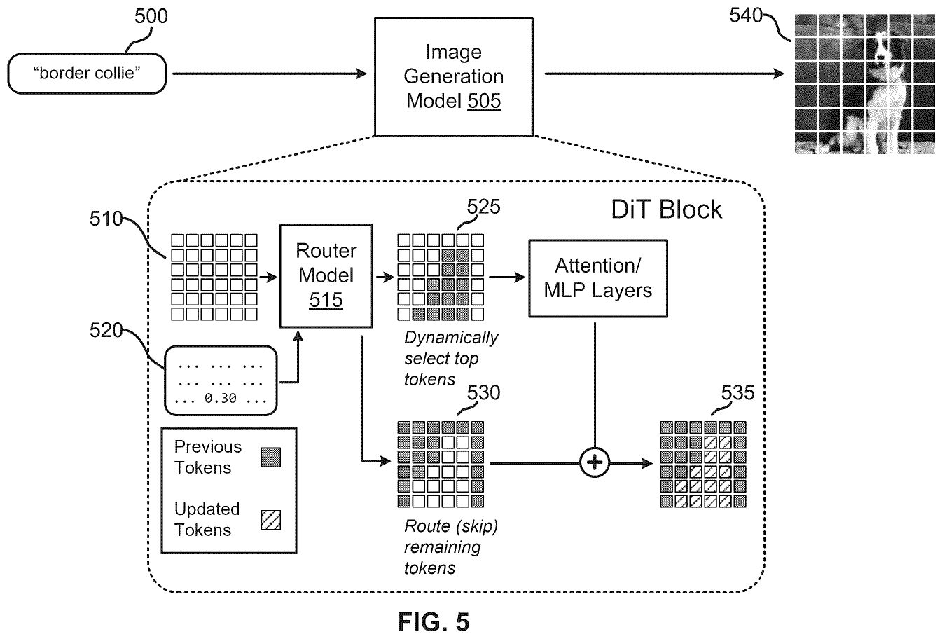

FIG. 2 shows an example of an image processing apparatus 200 according to aspects of the present disclosure. The example shown includes image processing apparatus 200, processor 205, memory 210, user interface 215, image generation model 220, and training component 230. Image processing apparatus 200 is an example of, or includes aspects of, the corresponding element described with reference to FIG. 1. Image generation model 220 is an example of, or includes aspects of, the corresponding element described with reference to FIG. 5. Router model 225 is an example of, or includes aspects of, the corresponding element described with reference to FIG. 5.

A processor 205 is an intelligent hardware device, (e.g., a general-purpose processing component, a digital signal processor 205 (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof). In some cases, processor 205 is configured to operate a memory array using a memory controller. In other cases, a memory controller is integrated into processor 205. In some cases, processor 205 is configured to execute computer-readable instructions stored in memory 210 to perform various functions. In some embodiments, processor 205 includes special purpose components for modem processing, baseband processing, digital signal processing, or transmission processing.

Memory 210 stores information used by image processing apparatus 200. For example, model parameters, explicit code and logic, compiled code, and data used by image generation model 220 may be stored in memory 210. Examples of a memory device include random access memory (RAM), read-only memory (ROM), or a hard disk. Examples of memory devices include solid state memory and a hard disk drive. In some examples, memory 210 is used to store computer-readable, computer-executable software including instructions that, when executed, cause processor 205 to perform various functions described herein. In some cases, memory 210 contains, among other things, a basic input/output system (BIOS) which controls basic hardware or software operation such as the interaction with peripheral components or devices. In some cases, a memory controller operates memory cells of memory 210. For example, the memory controller can include a row decoder, column decoder, or both. In some cases, memory cells within memory 210 store information in the form of a logical state.

User interface 215 enables a user to interact with image processing apparatus 200. In some embodiments, the user interface may include an audio device, such as an external speaker system, an external display device such as a display screen, or an input device (e.g., remote control device interfaced with the user interface directly or through an IO controller module). In some cases, a user interface may be a graphical user interface (GUI).

A user may provide inputs including a text prompt to the system via user interface 215. Though not shown, a text encoder may process the text prompt to generate a text embedding, which is a vector representation of the text prompt. The text embedding may then be used to condition the generation of synthetic image content. Examples of a text encoder include but are not limited to transformer-based encoders, such as the CLIP text encoder and the FlanT-5 encoder. Transformer models apply self-attention and cross-attention operations on character or word-level embeddings of text to capture contextual meaning.

A transformer or transformer network is a type of neural network model used for natural language processing tasks. A transformer network transforms one sequence into another sequence using an encoder and a decoder. Encoder and decoder include modules that can be stacked on top of each other multiple times. The modules comprise multi-head attention and feed forward layers. The inputs and outputs (target sentences) are first embedded into an n-dimensional space. Positional encoding of the different words (i.e., give every word/part in a sequence a relative position since the sequence depends on the order of its elements) are added to the embedded representation (n-dimensional vector) of each word. In some examples, a transformer network includes attention mechanism, where the attention looks at an input sequence and decides at each step which other parts of the sequence are important. The attention mechanism involves query, keys, and values denoted by Q, K, and V, respectively. Q is a matrix that contains the query (vector representation of one word in the sequence), K are all the keys (vector representations of all the words in the sequence) and V are the values, which are again the vector representations of all the words in the sequence. For the encoder and decoder, multi-head attention modules, V consists of the same word sequence than Q. However, for the attention module that is taking into account the encoder and the decoder sequences, V is different from the sequence represented by Q. In some cases, values in V are multiplied and summed with some attention-weights a.

Image generation model 220 may also incorporate Transformer components. For example, image generation model 220 may include a generative diffusion transformer model. Diffusion Transformers (DiTs) adapt the transformer architecture for image generation tasks by treating image patches as sequence elements analogous to words in text. In DiTs, an input image is first divided into patches which are linearly embedded into tokens. These tokens are augmented with learned positional embeddings to maintain spatial relationships. The tokens are then processed through a series of transformer blocks that may include self-attention mechanisms for modeling relationships between patches, cross-attention layers for incorporating conditional information such as text prompts, and feed-forward networks. Unlike language transformers which predict the next token in a sequence, DiTs are trained to predict noise that has been added to the input image according to a predefined diffusion schedule, enabling the model to gradually denoise corrupted images during the generation process.

In one aspect, image generation model 220 includes router model 225. Router model 225 is a trainable, lightweight neural network component configured to compute token importance scores at each layer and timestep of a diffusion transformer network. Router model 225 evaluates input tokens and assigns each token a score indicating its relative importance for the current processing stage. In conventional diffusion transformers implementing mixture-of-depths approaches, router models 225 select a fixed ratio of tokens (e.g., top 20% by importance score) to process through attention mechanisms, while allowing less important tokens to skip (e.g., be routed past) computation. These fixed ratios are typically maintained constant across all network layers and diffusion timesteps. However, embodiments of the present disclosure include router model 225 which is configured to not only order tokens by importance, but determine an adaptive, per-layer, per-timestep ratio of tokens to either apply attentions to or to skip to the next image generation stage, be it the next layer or the next timestep. The router model 225 thereby enables dynamic allocation of computational resources based on the varying complexity needs throughout the image generation process.

According to some aspects, image generation model 220 generates a set of image tokens based on the input prompt, where each of the set of image tokens represents an image region. In some examples, image generation model 220 performs an attention operation on a subset of the set of image tokens at the image generation stage based on the dynamic selectivity value determined by router model 225 to obtain an attention output. In some examples, image generation model 220 generates a synthetic image based on the attention output.

In some examples, image generation model 220 performs a subsequent attention operation on a subsequent subset of the set of image tokens at the subsequent image generation stage based on the updated dynamic selectivity value to obtain a subsequent attention output, where the synthetic image is based on the subsequent attention output. In some examples, image generation model 220 performs a diffusion denoising process to obtain the synthetic image.

Training component 230 is configured to update parameters of image generation model 220 in one or more training phases. For example, training component 230 may update DiT blocks of the image generation model 220 to configure the model to denoise an image sample, thereby generating synthetic image content. According to some aspects, training component 230 is further configured to train a router model to compute token importance scores and learn adaptive compression ratios for each layer and timestep of the generation process. The router model training enables the system to automatically determine optimal ratios of tokens to process or skip at different stages of image generation. Training component 230 may additionally train cross-attention layers within the DiT blocks to effectively incorporate conditioning information, such as text prompts, during the generation process. Additional training detail is described with reference to FIGS. 9-11.

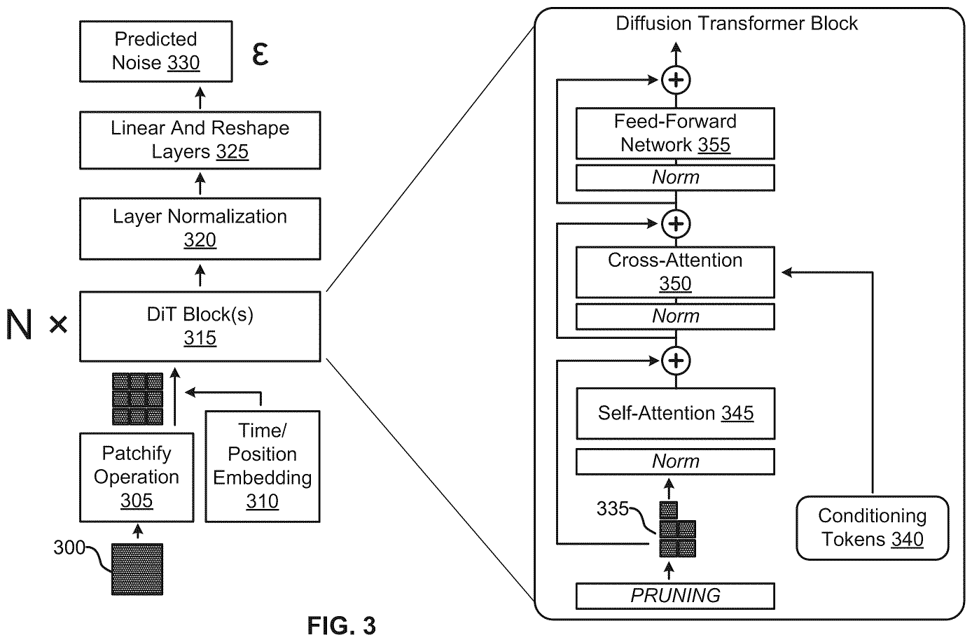

FIG. 3 shows an example of a diffusion transformer (DiT) architecture according to aspects of the present disclosure. The example shown includes noised latent 300, patchify operation 305, timestep embedding 310, DiT block(s), layer normalization 320, linear and reshape layers 325, predicted noise 330, input tokens 335, conditioning tokens 340, self-attention 345, cross-attention 350, and feed-forward network 355.

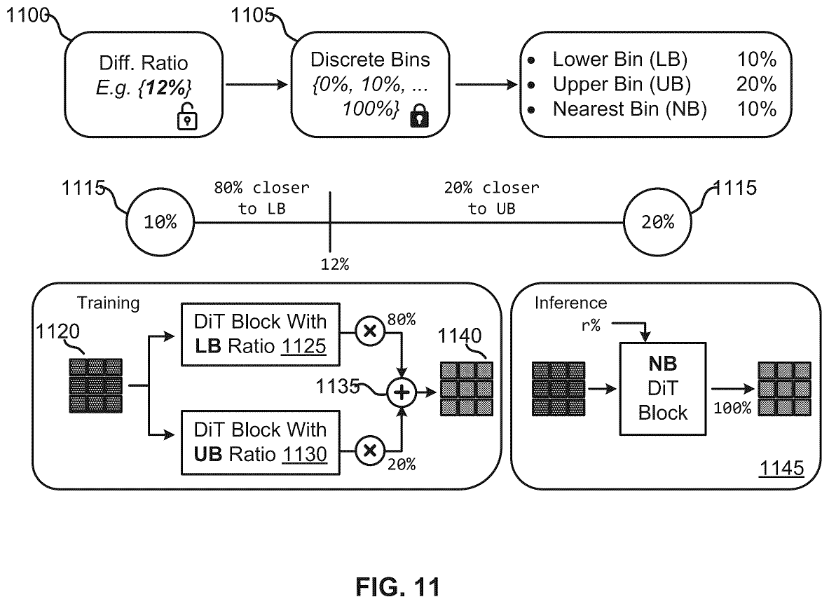

Patchify operation 305 is an example of, or includes aspects of, the corresponding element described with reference to FIG. 4. Input tokens 335 is an example of, or includes aspects of, the corresponding element described with reference to FIGS. 5 and 11.

The DiT architecture processes noised latent 300, which may be a noised version of an input image encoded in a latent space. Patchify operation 305 divides the noised latent into a sequence of patches that are processed as tokens. The tokens are vector representations of each patch of the image in latent space, and are adjusted through attention processes. Each of the tokens also receives timestep embedding 310, which encodes the current denoising timestep, and a positional embedding which encodes each token's spatial position in the image. The tokens and timestep information are processed through N DiT block(s) 315, where N may be 28 in some embodiments, though other values of N are possible.

Each DiT block 315 includes multiple processing stages. Initially, a pruning operation is performed where a router model (described with reference to FIG. 2) determines which tokens to process or skip based on learned, layer and timestep-adaptive compression ratios. The remaining tokens are processed as input tokens 335, which interact with conditioning tokens 340 through multiple attention mechanisms. Self-attention 345 allows input tokens to attend to each other, while cross-attention 350 enables input tokens to attend to the conditioning tokens 340. The outputs are then processed through feed-forward network 355. This process repeats for each DiT block in the sequence.

After processing through all DiT blocks, the outputs undergo layer normalization 320 followed by linear and reshape layers 325. The final output is predicted noise 330, which represents the model's prediction of the noise that was added to create the initial noised latent 300. The predicted noise 330 is removed noised latent 300 at each diffusion timestep. At the end of the denoising schedule, the latent sample is decoded to generate the synthetic image in pixel space.

### Efficient Image Generation

FIG. 4 shows an example of an image generation pipeline according to aspects of the present disclosure. The example shown includes input image and mask 400, patchify operation 405, image tokens 410, latent encoding 415, encoded image tokens 420, token dropping 425, selected tokens 430, text prompt 435, noise 440, patchify and encode operation 445, noise tokens 450, DiT block 455, output patches 460, blend 465, and inpainted image 470.

Input image and mask 400 is an example of, or includes aspects of, the corresponding element described with reference to FIG. 12. Patchify operation 405 is an example of, or includes aspects of, the corresponding element described with reference to FIG. 3. Selected tokens 430 is an example of, or includes aspects of, the corresponding element described with reference to FIG. 5. Text prompt 435 is an example of, or includes aspects of, the corresponding element described with reference to FIGS. 1, 5, and 12. DiT block 455 is an example of, or includes aspects of, the corresponding element described with reference to FIGS. 12 and 13. Inpainted image 470 is an example of, or includes aspects of, the corresponding element described with reference to FIG. 1.

The image generation pipeline demonstrates an approach for processing only relevant portions of an image for inpainting tasks. Input image and mask 400 represents an input image with a masked region to be filled with generated content. Patchify operation 405 divides the image into image tokens 410, which are then processed through latent encoding 415 to produce encoded image tokens 420 in a latent space more suitable for processing.

Token dropping 425 identifies and removes tokens that do not correspond to the masked region, resulting in selected tokens 430 that contain encoded information about the regions surrounding the mask. These selected tokens provide global context for the generation process. Separately, the system generates noise 440 matching the dimensions of the masked region. This noise undergoes patchify and encode operations 445 to produce noise tokens 450.

Text prompt 435 (e.g. “jalapeno pepper”) provides conditioning information that guides the generation process. DiT block 455 processes the noise tokens along with the contextual information from the selected tokens and text prompt to generate output patches 460. Through multiple denoising iterations, the DiT block gradually refines these patches. This process is described in greater detail with reference to FIG. 3. Finally, blend 465 combines the generated content with the original image to produce inpainted image 470.

In this example, the system focuses computational resources on only the tokens necessary for filling the masked region. However, embodiments of the present disclosure include an image generation model with a dedicated routing model that further increases efficiency through adaptive token pruning, and may be applied to both inpainting and text-to-image tasks.

FIG. 5 shows an example of a pipeline for efficient token selection according to aspects of the present disclosure. The example shown includes text prompt 500, image generation model 505, input tokens 510, router model 515, determined compression ratio 520, selected tokens 525, skipped tokens 530, output tokens 535, and synthetic image 540.

According to some embodiments, an image generation model performs efficient image generation by selecting processing input tokens 510 using the router model 515. For example, the router model 515 can be a machine learning model (or a part of a machine learning model) trained to compute an importance score for each of the input tokens 510. Then, a subset of the input tokens 510 can be selected by comparing the corresponding importance score to a threshold value (i.e., a dynamic selectivity value). The dynamic selectivity value can change dynamically based on the layer of the image generation model or the diffusion timestep. After the selection, the selected subset of the input tokens 510 can be further processed (e.g., at an attention layer of the image generation model) and one or more non-selected tokens can bypass the processing performed on the selected tokens.

By selectively processing important tokens and refraining from processing the non-selected tokens, the synthetic image 540 can be generated more efficiently without sacrificing detail or accuracy in the most important regions of the synthetic image 540. In some cases, by changing the dynamic selectivity value at different image generation stages, those stages that influence the quality of more regions of the image can process more tokens, thereby achieving a better tradeoff between accuracy and efficiency.

Text prompt 500 is an example of, or includes aspects of, the corresponding element described with reference to FIGS. 1, 4, and 12. Image generation model 505 is an example of, or includes aspects of, the corresponding element described with reference to FIG. 2. Input tokens 510 is an example of, or includes aspects of, the corresponding element described with reference to FIGS. 3 and 11. Router model 515 is an example of, or includes aspects of, the corresponding element described with reference to FIG. 2. Selected tokens 525 is an example of, or includes aspects of, the corresponding element described with reference to FIG. 4. Output tokens 535 is an example of, or includes aspects of, the corresponding element described with reference to FIG. 11.

During operation, image generation model 505 processes input tokens 510 through multiple DiT blocks to gradually generate synthetic image 540 in response to text prompt 500. Within each DiT block, router model 515 computes an importance score for each input token based on the token's content and context. These importance scores determine an ordering of the tokens based on their relative importance to the current generation stage. Router model 515 then uses this ordering along with determined compression ratio 520 to identify which tokens should undergo attention processing and which can be skipped.

According to some aspects, the importance scores computed by router model 515 are data-dependent, meaning they are influenced by the actual content being processed. In contrast, determined compression ratio 520 is architecture and training-dependent, having been learned during model training to optimize efficiency across different layers and timesteps of the generation process. Based on both the token-specific importance scores and the determined compression ratio, router model 515 separates input tokens 510 into selected tokens 525 and skipped tokens 530.

Selected tokens 525 undergo full attention and feed-forward processing within the DiT block, while skipped tokens 530 bypass these computationally intensive operations. The processed selected tokens are then combined with the skipped tokens to produce output tokens 535, maintaining the full token count while reducing computational overhead. This process repeats through multiple DiT blocks and denoising timesteps until the final synthetic image 540 is generated. In this way, the image generation model of the present disclosure achieves improved efficiency by learning optimal compression ratios that automatically adapt to allocate computational resources where they are most needed throughout the generation process.

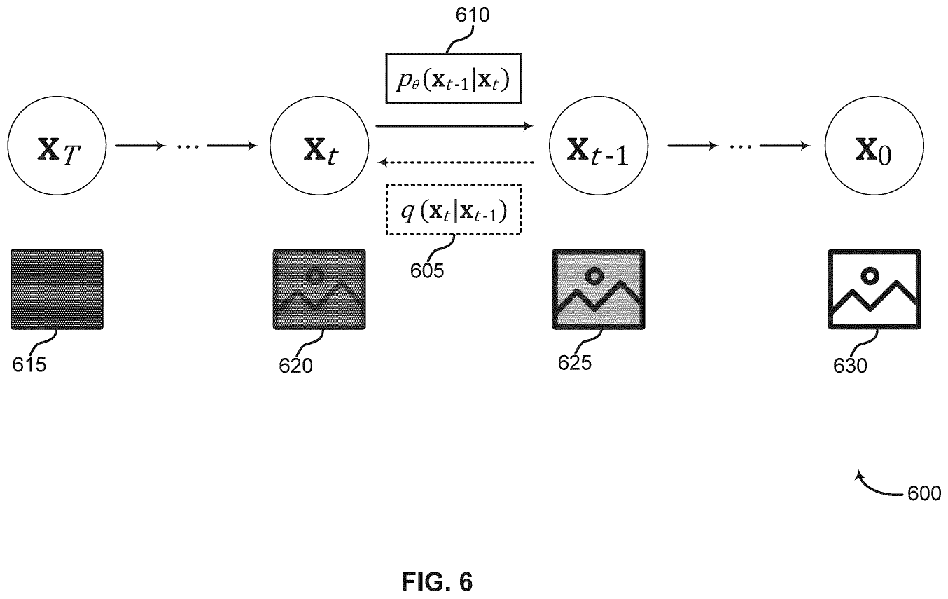

FIG. 6 shows a diffusion process 600 according to aspects of the present disclosure. In some examples, diffusion process 600 describes an operation of the image generation model 220 described with reference to FIG. 2.

Using a diffusion model, such as a U-Net-based diffusion model or a DiT, can involve both a forward diffusion process 605 for adding noise to an image (or features in a latent space) and a reverse diffusion process 610 for denoising the images (or features) to obtain a denoised image. The forward diffusion process 605 can be represented as q(xₜ|xₜ₋₁), and the reverse diffusion process 610 can be represented as p(xₜ₋₁|xₜ). In some cases, the forward diffusion process 605 is used during training to generate images with successively greater noise, and a neural network is trained to perform the reverse diffusion process 610 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 610, the model begins with noisy data x_{T}, such as a noisy image 615 and denoises the data to obtain the p(xₜ₋₁|xₜ). At each step t−1, the reverse diffusion process 610 takes xₜ₋₁, such as first intermediate image 620, and t as input. Here, t represents a step in the sequence of transitions associated with different noise levels, The reverse diffusion process 610 outputs xₜ₋₁, such as second intermediate image 625 iteratively until x-reverts back to x₀, the original image 630. The reverse process can be represented as:

$${p}_{θ} ( {x}_{t - 1} \vert {x}_{t} ) := N ( {x}_{t - 1} ; {μ}_{θ} ( {x}_{t} , t ) , {\sum }_{θ} ( {x}_{t} , t ) ) \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) \qquad ( 2 )$$

where p(x_{T})=N(x_{T}; 0, 1) is the pure noise distribution as the reverse process takes the outcome of the forward process, a sample of pure noise, as input and

$${\prod }_{t = 1}^{T} {p}_{θ} ( {x}_{t - 1} \vert {x}_{t} )$$

represents a sequence of Gaussian transitions corresponding to a sequence of addition of Gaussian noise to the sample.

At inference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

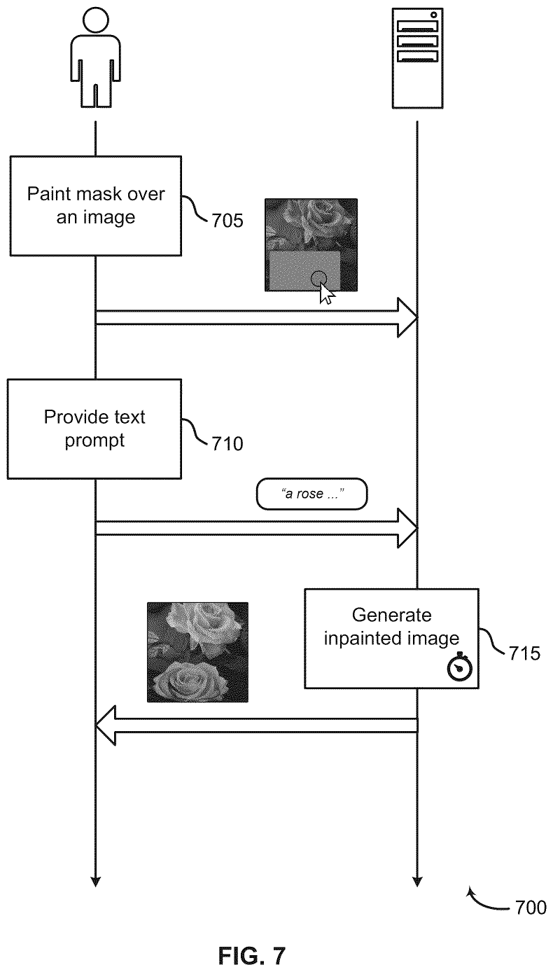

FIG. 7 shows an example of a method 700 for inpainting an image according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 705, the user paints a mask over an image. The user may do so via a user interface such as the one described with reference to FIG. 2. For example, the user may select a region of the image that they wish to replace with generated content using a pen tool, a shape drawing tool, a quick-select tool, or similar.

At operation 710, the user provides a text prompt. For example, the user may provide a written description of the content to be generated. In some embodiments, the user may provide additional conditioning beyond the text prompt such as reference images, videos, sounds, 3D models, etc.

At operation 715, the system generates an inpainted image. According to some aspects, this operation is performed by an image generation model configured to generate synthetic content by performing an iterative denoising process. Additional details regarding the generative process are provided with reference to FIGS. 3-5. The system may generate the image with approximately half the compute of comparable image generation models, and with similar or better quality.

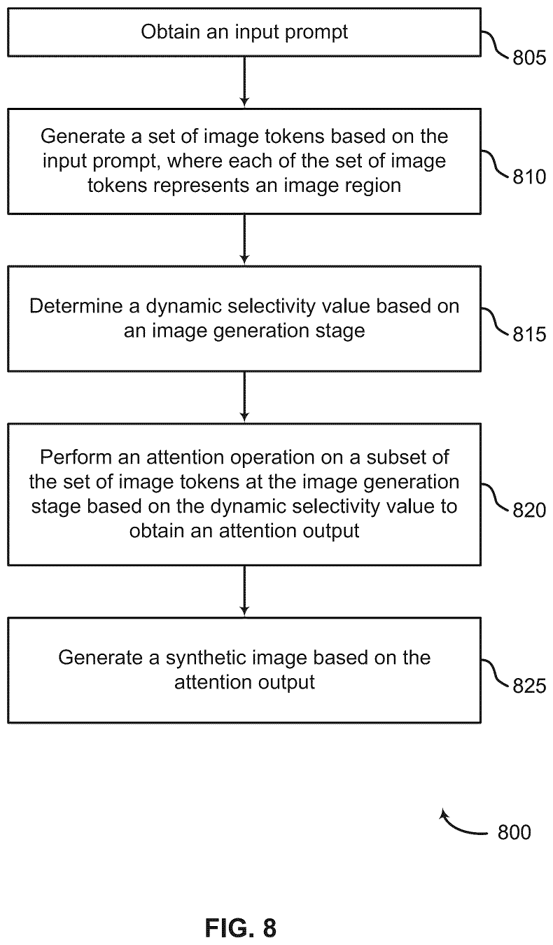

FIG. 8 shows an example of a method 800 for generating images with dynamic token selection according to aspects of the present disclosure. In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

At operation 805, the system obtains an input prompt. In some cases, the operations of this step refer to, or may be performed by, an image processing apparatus as described with reference to FIGS. 1 and 2. The input prompt may be a text prompt, an image with a user-indicated mask, or a combination thereof.

At operation 810, the system generates a set of image tokens based on the input prompt, where each of the set of image tokens represents an image region. In some cases, the operations of this step refer to, or may be performed by, an image generation model as described with reference to FIGS. 2, 3, and 5. For example, the system may perform patchify operations to split the image into regions, and generate an embedding for each region referred to as a ‘token’. If the user provided a masked image, the system may patchify the user-provided image and the mask, and initialize a separate set of noise tokens corresponding to the region of the mask. If the user did not provide an image, then the system may initialize a set of noise tokens corresponding to the final dimensions of the image to be generated.

At operation 815, the system determines a dynamic selectivity value based on an image generation stage. In some cases, the operations of this step refer to, or may be performed by, a router model as described with reference to FIGS. 2 and 5. The dynamic selectivity value determines, at each image generation stage, which tokens are processed before the next stage and which are routed directly to the next stage. The router model ranks the tokens by order of importance, and then references a learned compression ratio (e.g., the dynamic selectivity value) that determines what proportion of the top tokens are selected for processing.

At operation 820, the system performs an attention operation on a subset of the set of image tokens at the image generation stage based on the dynamic selectivity value to obtain an attention output. In some cases, the operations of this step refer to, or may be performed by, an image generation model as described with reference to FIGS. 2 and 5. Additional detail regarding attention and transformers is provided with reference to FIG. 2.

At operation 825, the system generates a synthetic image based on the attention output. In some cases, the operations of this step refer to, or may be performed by, an image generation model as described with reference to FIGS. 2 and 5. The image generation model may perform an iterative denoising process to generate the synthetic image. Additional detail regarding the image generation process is provided with reference to FIGS. 3, 5, and 6.

### Training the System

FIG. 9 is a flow diagram depicting an algorithm as a step-by-step procedure 900 in an example implementation of operations performable for training a machine-learning model. In some embodiments, the procedure 900 describes an operation of the training component 230 that configures the image generation model 220 described with reference to FIG. 2. The procedure 900 provides one or more examples of generating training data, use of the training data to train a machine-learning model, and use of the trained machine-learning model to perform a task.

To begin in this example, a machine-learning system collects training data (block 902) that is to be used as a basis to train a machine-learning model, i.e., which defines what is being modeled. The training data is collectable by the machine-learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and edited data generation techniques to expand and diversify available training data, balancing techniques to balance a number of positive and negative examples, and so forth.

The machine-learning system is also configurable to identify features that are relevant (block 904) to a type of task, for which the machine-learning model is to be trained. Task examples include classification, natural language processing, generative artificial intelligence, recommendation engines, reinforcement learning, clustering, and so forth. To do so, the machine-learning system collects the training data based on the identified features and/or filters the training data based on the identified features after collection. The training data is then utilized to train a machine-learning model.

In order to train the machine-learning model in the illustrated example, the machine-learning model is first initialized (block 906). Initialization of the machine-learning model includes selecting a model architecture (block 908) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 910). The loss function is utilized to measure a difference between an output of the machine-learning model (i.e., predictions) and target values (e.g., as expressed by the training data) to be used to train the machine-learning model. This loss function may include, for example, the OCR loss as described with reference to FIG. 11. Additionally, an optimization algorithm is selected (912) that is to be used in conjunction with the loss function to optimize parameters of the machine-learning model during training, examples of which include gradient descent, stochastic gradient descent (SGD), and so forth.

Initialization of the machine-learning model further includes setting initial values of the machine-learning model (block 914) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine-learning model is then trained using the training data (block 918) by the machine-learning system. A machine-learning model refers to a computer representation that can be tuned (e.g., trained and retrained) based on inputs of the training data to approximate unknown functions. In particular, the term machine-learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine-learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine-learning model to perform an associated task.

As part of training the machine-learning model, a determination is made as to whether a stopping criterion is met (decision block 920), i.e., which is used to validate the machine-learning model. The stopping criterion is usable to reduce overfitting of the machine-learning model, reduce computational resource consumption, and promote an ability of the machine-learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 920), the procedure 900 continues training of the machine-learning model using the training data (block 918) in this example.

If the stopping criterion is met (“yes” from decision block 920), the trained machine-learning model is then utilized to generate an output based on subsequent data (block 922). The trained machine-learning model, for instance, is trained to perform a task as described above and therefore, once trained, is configured to perform that task based on subsequent data received as an input and processed by the machine-learning model.

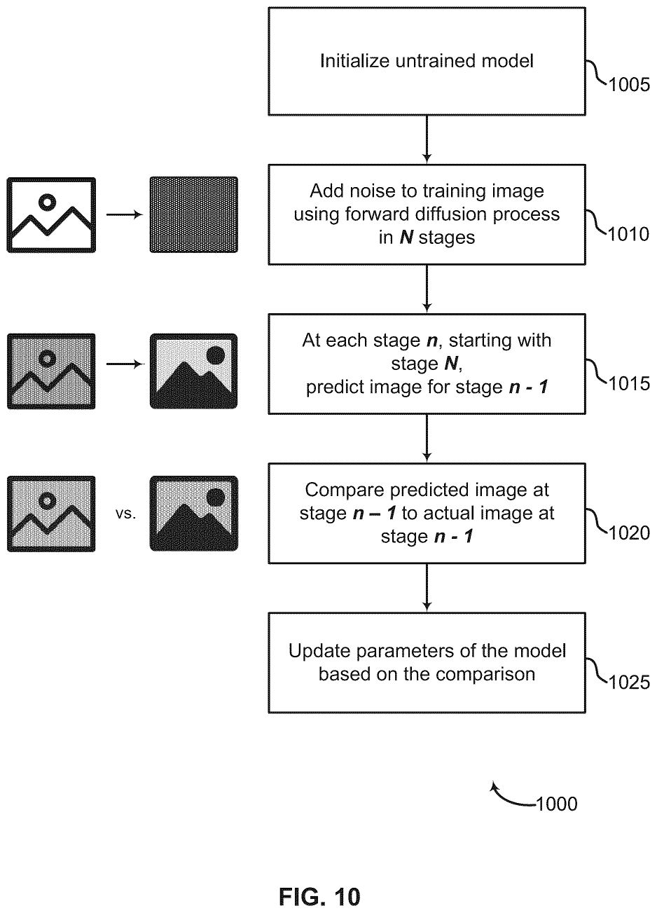

FIG. 10 shows an example of a method 1000 for training a diffusion model according to aspects of the present disclosure. In some embodiments, the method 1000 describes an operation of the training component 230 described for configuring the image generation model 220 as described with reference to FIG. 2. The method 1000 represents an example for training a reverse diffusion process as described above with reference to FIG. 6. In some examples, these operations are performed by a system including a processor executing a set of codes to control functional elements of an apparatus, such as the diffusion model described in FIG. 3.

Additionally or alternatively, certain processes of method 1000 may be performed using special-purpose hardware. Generally, these operations are performed according to the methods and processes described in accordance with aspects of the present disclosure. In some cases, the operations described herein are composed of various substeps or are performed in conjunction with other operations.

At operation 1005, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1010, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1015, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1020, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1025, the system updates parameters of the model based on the comparison. For example, parameters of a U-Net may be updated using gradient descent. Time-dependent parameters of the Gaussian transitions can also be learned.

FIG. 11 shows an example of a training pipeline for determining adaptive compression ratios according to aspects of the present disclosure. The example shown includes differentiable compression ratio 1100, discrete ratio bins 1105, selected bins 1110, bin proximity coefficients 1115, input tokens 1120, DiT block with lower bin ratio 1125, DiT block with upper bin ratio 1130, weighted combination 1135, output tokens 1140, and inference process 1145.

Input tokens 1120 is an example of, or includes aspects of, the corresponding element described with reference to FIGS. 3 and 5. Output tokens 1140 is an example of, or includes aspects of, the corresponding element described with reference to FIG. 5.

During training, differentiable compression ratio 1100 is a learnable parameter that determines how many tokens will be processed at a particular block and timestep. By referencing discrete ratio bins 1105, which contain fixed values like 0%, 10%, and 20%, the system identifies selected bins 1110 including both a lower bin (LB) ratio, an upper bin (UB) ratio, and a nearest bin (NB) ratio. Bin proximity coefficients 1115 are then calculated based on how close differentiable compression ratio 1100 is to each selected bin—for example, a ratio of 12% would result in coefficients of 80% for the 10% bin and 20% for the 20% bin.

Input tokens 1120 are then processed through two parallel paths: DiT block with lower bin ratio 1125 and DiT block with upper bin ratio 1130. The outputs from these blocks undergo weighted combination 1135 according to their respective bin proximity coefficients 1115, producing output tokens 1140. This weighted combination creates a continuous path for gradients to flow despite the discrete nature of token selection. When the loss between output tokens 1140 and ground-truth data is computed, these gradients inform whether differentiable compression ratio 1100 should increase or decrease based on which bin ratio's output was more effective at minimizing the loss.

In some aspects, the training process may include additional constraints to ensure practical efficiency gains. The differentiable compression ratio 1100 may be constrained by an additional loss term that encourages the average compression ratio across all blocks and timesteps to converge to a target efficiency value. This balances the objectives for optimal per-block and per-timestep compression ratios with overall computational efficiency. For example, the training process may incorporate an average or per-image-generation stage ratio as a hyperparameter.

During inference process 1145, the system uses the DiT block with the nearest bin ratio for a given block and timestep, eliminating the need for parallel processing paths and weighted combinations. The resulting discretized ratios provide a lookup table that determines the optimal compression ratio for each combination of DiT block and diffusion timestep, thereby enabling efficient resource allocation during image generation.

### Results

FIG. 12 shows an example of router model prediction results according to aspects of the present disclosure. The example shown includes input image and mask 1200, text prompt 1205, timestep 1210, DiT block 1215, router model predictions 1220, and generation progress images 1225.

Input image and mask 1200 is an example of, or includes aspects of, the corresponding element described with reference to FIG. 4. Text prompt 1205 is an example of, or includes aspects of, the corresponding element described with reference to FIGS. 1, 4, and 5. DiT block 1215 is an example of, or includes aspects of, the corresponding element described with reference to FIGS. 4 and 13.

Router model predictions 1220 depict the attention maps at each timestep 1210 for each DiT block 1215. A brighter spot indicates that that corresponding token was more important during the image generation process at that particular image generation stage. The regions that do not overlap with the mask were unprocessed, and are therefore dark. This result shows that at the earliest layers of the image generation model (e.g., the first few DiT blocks), the tokens are not extensively processed. The final layers are utilized at each timestep. Further, generally, there is more computation near the later timesteps of the generation. Generation progress images 1225 depict a snapshot view of the inpainting process throughout generation.

FIG. 13 shows an example of learned adaptive compression ratios for different tasks according to aspects of the present disclosure. The example shown includes inpainting task ratios 1300, from-scratch text-to-image task ratios 1310, and DiT block 1320. DiT block 1320 is an example of, or includes aspects of, the corresponding element described with reference to FIGS. 4 and 12.

In this example, the inpainting generative task, which inpaints as portion of an existing image, is split into 10 timestep regions (e.g., first timestep regions 1305 with 10 timesteps each). The text-to-image generative task, which generates a wholly new image, is split into 40 timestep regions (e.g., second timestep regions 1315 with 10 timesteps each). The colors in inpainting task ratios 1300 and from-scratch text-to-image task ratios 1310 represent the learned compression ratios for a given layer (e.g. DiT block 1320), averaged across the timesteps in a timestep region.

The results indicate some non-intuitive behavior of the image generation model. For example, when inpainting, there are substantial efficiency gains with higher compression ratios in the first two layers over all diffusion timesteps. However, the training process has determined that the third layer is better configured to have less compression. Another insight is that the text-to-image generative task drastically changes the compression ratio across timesteps, unlike the inpainting task. The training methods described herein may be applied to various DiT architectures configured for various tasks to obtain per-layer, per-timestep compression ratios and thereby optimize computation allocation and output quality.

FIG. 14 shows an example of a computing device 1400 according to aspects of the present disclosure. The example shown includes computing device 1400, processor(s) 1405, memory subsystem 1410, communication interface 1415, I/O interface 1420, user interface component(s), and channel 1430.

In some embodiments, computing device 1400 is an example of, or includes aspects of, an image generation apparatus as described in FIGS. 1 and 2. In some embodiments, computing device 1400 includes one or more processors 1405 are configured to execute instructions stored in memory subsystem 1410 to obtain an input prompt; generate a plurality of image tokens based on the input prompt, wherein each of the plurality of image tokens represents an image region; determine a dynamic selectivity value based on an image generation stage; perform, using an image generation model, an attention operation on a subset of the plurality of image tokens at the image generation stage based on the dynamic selectivity value to obtain an attention output; and generate, using the image generation model, a synthetic image based on the attention output.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. The memory may store various parameters of machine learning models used in the components described with reference to FIG. 2. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating systems. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

Accordingly, the present disclosure includes the following aspects.

A method for image generation is described. One or more aspects of the method include obtaining an input prompt; generating a plurality of image tokens based on the input prompt, wherein each of the plurality of image tokens represents an image region; determining a dynamic selectivity value based on an image generation stage; performing, using an image generation model, an attention operation on a subset of the plurality of image tokens at the image generation stage based on the dynamic selectivity value to obtain an attention output; and generating, using the image generation model, a synthetic image based on the attention output.

Some examples of the method, apparatus, non-transitory computer readable medium, and system further include computing an importance score for each of the plurality of image tokens. Some examples further include ordering the plurality of image tokens based on the importance score. Some examples further include selecting the subset of the plurality of image tokens based on the ordering and the dynamic selectivity value. In some aspects, the image generation stage comprises a layer of the image generation model, a diffusion timestep, or a combination thereof.

Some examples of the method, apparatus, non-transitory computer readable medium, and system further include determining an updated dynamic selectivity value based on a subsequent image generation stage. Some examples further include performing, using the image generation model, a subsequent attention operation on a subsequent subset of the plurality of image tokens at the subsequent image generation stage based on the updated dynamic selectivity value to obtain a subsequent attention output, wherein the synthetic image is based on the subsequent attention output. In some aspects, the input prompt comprises an image with an inpainting region, wherein the synthetic image depicts generated content in the inpainting region.

Some examples of the method, apparatus, non-transitory computer readable medium, and system further include performing a diffusion denoising process to obtain the synthetic image. In some aspects, the image generation model is trained to determine the dynamic selectivity value based on the image generation stage.

A method for image generation is described. One or more aspects of the method include ordering a plurality of image tokens based on an input prompt, wherein each of the plurality of image tokens represents an image region; determining a dynamic selectivity value based on an image generation stage; selecting a subset of the plurality of image tokens based on the ordering and the dynamic selectivity value; and generating, using an image generation model, a synthetic image by selectively processing the subset of the plurality of image tokens at the image generation stage.

Some examples of the method, apparatus, non-transitory computer readable medium, and system further include computing an importance score for each of the plurality of image tokens. Some examples further include ordering the plurality of image tokens based on the importance score. Some examples further include performing, using the image generation model, an attention operation on the subset of the plurality of image tokens at the image generation stage based on the dynamic selectivity value to obtain an attention output, wherein the synthetic image is generated based on the attention output.

Some examples of the method, apparatus, non-transitory computer readable medium, and system further include determining an updated dynamic selectivity value based on a subsequent image generation stage. Some examples further include performing, using the image generation model, a subsequent attention operation on a subsequent subset of the plurality of image tokens at the subsequent image generation stage based on the updated dynamic selectivity value to obtain a subsequent attention output, wherein the synthetic image is based on the subsequent attention output.

In some aspects, the image generation stage comprises a layer of the image generation model, a diffusion timestep, or a combination thereof. In some aspects, the input prompt comprises an image with an inpainting region, wherein the synthetic image depicts generated content in the inpainting region.

Some examples of the method, apparatus, non-transitory computer readable medium, and system further include performing a diffusion denoising process to obtain the synthetic image. In some aspects, the image generation model is trained to determine the dynamic selectivity value based on the image generation stage.

An apparatus for image generation is described. One or more aspects of the apparatus include a memory component; a processing device coupled to the memory component, the processing device configured to perform operations comprising: obtaining an input prompt; generating a plurality of image tokens based on the input prompt, wherein each of the plurality of image tokens represents an image region; determining a dynamic selectivity value based on an image generation stage; performing, using an image generation model, an attention operation on a subset of the plurality of image tokens at the image generation stage based on the dynamic selectivity value to obtain an attention output; and generating, using the image generation model, a synthetic image based on the attention output.

Some examples of the apparatus, system, and method further include a router model configured to compute an importance score for each of the plurality of image tokens. In some aspects, the router model is trained to determine the dynamic selectivity value based on the image generation stage. Some examples of the apparatus, system, and method further include a diffusion transformer (DiT) model. In some aspects, the input prompt comprises an image with an inpainting region, wherein the synthetic image depicts generated content in the inpainting region.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

What is claimed is:

1. A method comprising:
obtaining an input prompt;
generating a plurality of image tokens based on the input prompt, wherein each of the plurality of image tokens represents an image region;
performing, using an image generation model, an attention operation on a subset of the plurality of image tokens at an image generation stage to obtain an attention output, wherein the subset of the plurality of image tokens is determined based on the image generation stage; and
generating, using the image generation model, a synthetic image based on the attention output.

2. The method of claim 1, further comprising:
computing an importance score for each of the plurality of image tokens;
ordering the plurality of image tokens based on the importance score; and
selecting the subset of the plurality of image tokens based on the ordering.

3. The method of claim 1, wherein:
determining a dynamic selectivity value based on an image generation stage, wherein the subset of the plurality of image tokens is determined based on the dynamic selectivity value.

4. The method of claim 3, further comprising:
determining an updated dynamic selectivity value for a subsequent image generation stage based on gradient backpropagation during a training iteration; and
performing, using the image generation model, a subsequent attention operation on a subsequent subset of the plurality of image tokens at the subsequent image generation stage based on the updated dynamic selectivity value to obtain a subsequent attention output, wherein the synthetic image is based on the subsequent attention output.

5. The method of claim 1, wherein:
the input prompt comprises an image with an inpainting region, wherein the synthetic image depicts generated content in the inpainting region.

6. The method of claim 1, wherein generating the synthetic image comprises:
performing a diffusion denoising process to obtain the synthetic image.

7. The method of claim 1, wherein:
the image generation model is trained to determine a dynamic selectivity value based on the image generation stage.

8. A non-transitory computer readable medium storing code for image processing, the code comprising instructions that, when executed by at least one processor, cause the at least one processor to perform operations comprising:
obtaining an input prompt;
scoring a plurality of image tokens based on the input prompt, wherein each of the plurality of image tokens represents an image region;
determining a dynamic selectivity value based on an image generation stage;
selecting a subset of the plurality of image tokens based on the scoring and the dynamic selectivity value; and
generating, using an image generation model, a synthetic image by processing the selected subset of the plurality of image tokens at the image generation stage.

9. The non-transitory computer readable medium of claim 8, wherein scoring the plurality of image tokens comprises:
computing an importance score for each of the plurality of image tokens; and
ordering the plurality of image tokens based on the importance score.

10. The non-transitory computer readable medium of claim 8, wherein generating the synthetic image comprises:
performing, using the image generation model, an attention operation on the subset of the plurality of image tokens at the image generation stage based on the dynamic selectivity value to obtain an attention output, wherein the synthetic image is generated based on the attention output.

11. The non-transitory computer readable medium of claim 10, wherein generating the synthetic image further comprises:
determining an updated dynamic selectivity value based on a subsequent image generation stage; and
performing, using the image generation model, a subsequent attention operation on a subsequent subset of the plurality of image tokens at the subsequent image generation stage based on the updated dynamic selectivity value to obtain a subsequent attention output, wherein the synthetic image is based on the subsequent attention output.

12. The non-transitory computer readable medium of claim 8, wherein:
the image generation stage comprises a layer of the image generation model, a diffusion timestep, or a combination thereof.

13. The non-transitory computer readable medium of claim 8, wherein:
the input prompt comprises an image with an inpainting region, wherein the synthetic image depicts generated content in the inpainting region.

14. The non-transitory computer readable medium of claim 8, wherein generating the synthetic image comprises:
performing a diffusion denoising process to obtain the synthetic image.

15. The non-transitory computer readable medium of claim 8, wherein:
the image generation model is trained to determine the dynamic selectivity value based on the image generation stage.

16. A system comprising:
a memory component;
a processing device coupled to the memory component, the processing device configured to perform operations comprising:
obtaining an input prompt;
generating a plurality of image tokens based on the input prompt, wherein each of the plurality of image tokens represents an image region;
performing, using an image generation model, an attention operation on a subset of the plurality of image tokens determined based on an image generation stage to obtain an attention output; and
generating, using the image generation model, a synthetic image based on the attention output.

17. The system of claim 16, wherein the image generation model comprises:
a router model configured to compute an importance score for each of the plurality of image tokens.

18. The system of claim 17, wherein:
the router model is trained to determine a dynamic selectivity value based on the image generation stage.

19. The system of claim 16, wherein the image generation model comprises:
a diffusion transformer (DiT) model.

20. The system of claim 16, wherein:
the input prompt comprises an image with an inpainting region, wherein the synthetic image depicts generated content in the inpainting region.
